(19) United States
(12) Patent Application Publication
(10) Pub. No.: US 2026/0061723 A1
(43) Pub. Date: Mar. 5, 2026

(54) ADHESIVE STRUCTURE AND METHOD FOR MANUFACTURING ADHESIVE STRUCTURE

(71) Applicant: SUBARU CORPORATION, Tokyo (JP)

(72) Inventor: Yugo TOMITA, Tokyo (JP)

(73) Assignee: SUBARU CORPORATION, Tokyo (JP)

(21) Appl. No.: 19/293,660

(22) Filed: Aug. 7, 2025

(30) Foreign Application Priority Data
Sep. 4, 2024 (JP) 2024-152016

(51) Int. Cl. B32B 7/12; B32B 15/18; B32B 37/12

(52) U.S. Cl. CPC B32B 7/12; B32B 15/18; B32B 37/12; B32B 2037/1261; B32B 2255/06; B32B 2255/26; B32B 2307/7376; B32B 2605/08

(57) ABSTRACT

An adhesive structure includes a first adherend, a first plasma polymer layer, an adhesive layer, a second plasma polymer layer, and a second adherend in this order. Each of the first plasma polymer layer and the second plasma polymer layer contains an organopolysiloxane as a main component. A thickness of each of the first plasma polymer layer and the second plasma polymer layer is in a range of 10 nm to 100 nm.

### CROSS-REFERENCE TO RELATED APPLICATIONS

The present application claims priority from Japanese Patent Application No. 2024-152016 filed on Sep. 4, 2024, the entire contents of which are hereby incorporated by reference.

### BACKGROUND

The disclosure relates to an adhesive structure and a method for manufacturing the adhesive structure, for example, to an adhesive structure in which an adhesive layer is formed on an adherend and a method for manufacturing the adhesive structure.

For a purpose of improving automobile vehicle performance (steering stability, NVH performance, collision safety, fatigue durability, and rust prevention property) and reducing a vehicle weight, a structural adhesive is used in bonding structural members to be strong and durable (for example, bonding structural members in a vehicle body and a battery case).

As this structural adhesive, for example, Japanese Unexamined Patent Application Publication (JP-A) No. 2024-62849 discloses an epoxy-based structural adhesive for bonding metal members and the like in the field of automobiles and the like.

### SUMMARY

An aspect of the disclosure provides an adhesive structure. The adhesive structure includes a first adherend, a first plasma polymer layer, an adhesive layer, a second plasma polymer layer, and a second adherend in this order. Each of the first plasma polymer layer and the second plasma polymer layer contains an organopolysiloxane as a main component. A thickness of each of the first plasma polymer layer and the second plasma polymer layer is in a range of 10 nm to 100 nm.

An aspect of the disclosure provides a method for manufacturing the adhesive structure. The method includes: forming the first plasma polymer layer on the first adherend by a plasma polymer coating apparatus; forming the second plasma polymer layer on the second adherend by the plasma polymer coating apparatus; applying an adhesive to one or both of the first plasma polymer layer the second plasma polymer layer; bonding the first adherend on which the first plasma polymer layer is formed and the second adherend on which the second plasma polymer layer is formed with the adhesive interposed therebetween; and curing the adhesive to obtain the adhesive layer.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a diagram illustrating a configuration of an adhesive structure of the disclosure;

FIG. 2 is a diagram illustrating results of an influence of the thickness of a plasma polymer layer on initial adhesive strength and a strength residual ratio after wet deterioration;

FIG. 3 is a diagram illustrating a state in which destruction has occurred in the plasma polymer layer when the thickness of the plasma polymer layer exceeds 100 nm; and

FIG. 4 is a diagram illustrating results of a strength change ratio of the adhesive structure under constant temperature and constant humidity.

### DETAILED DESCRIPTION

In a structural adhesive such as the epoxy-based structural adhesive disclosed in JP-A No. 2024-62849, an acrylic adhesive, or a urethane-based adhesive, an aging deterioration phenomenon of adhesive performance (for example, a decrease in adhesive strength of the structural adhesive over time) may occur. Furthermore, there is a possibility that vehicle performance deteriorates due to the aging deterioration phenomenon of adhesion performance.

As a countermeasure for suppressing the aging deterioration phenomenon of the structural adhesive, in some automobiles, attention is paid to the fact that this aging deterioration phenomenon occurs due to a decrease in adhesive force at an adhesion interface between the structural adhesive and an adherend, and in order to prevent this decrease in adhesive force, an organic film is provided between the structural adhesive and the adherend.

However, in a case of suppression countermeasure by an existing organic film, in order to form the organic film on an adherend, a treatment bath for immersing the adherend in a surface treatment liquid is introduced into a manufacturing process. For example, in a case of forming the organic film on the adherend after press working, a large treatment facility is used as compared with a case of forming the organic film on the adherend before press working, and introduction cost is large. On the other hand, in a case of forming the organic film on the adherend before press working, since the organic film cannot withstand high temperatures, hot stamping (press working in a high temperature state) cannot be performed on the adherend, and the material and shape of the adherend are limited. As described above, even an adhesive structure having an organic film is insufficient as a countermeasure for suppressing the aging deterioration phenomenon of adhesive performance, and a suppression countermeasure different from the existing technique is to be adopted.

It is desirable to provide an adhesive structure capable of suppressing an aging deterioration phenomenon of adhesive performance (for example, a decrease in adhesive strength of a structural adhesive over time) without having the above-described drawbacks in the suppression countermeasure by the existing organic film using a suppression countermeasure different from the countermeasure for suppressing the aging deterioration phenomenon by the existing organic film.

The present inventors have intensively conducted studies for achieving the above-described object, and as a result, have found that the above-described problems can be solved by providing a plasma polymer layer containing a specific component as a main component between an adherend and an adhesive layer, and furthermore setting the thickness of the plasma polymer layer in a specific range, and have completed the disclosure.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### <Configuration of Adhesive Structure>

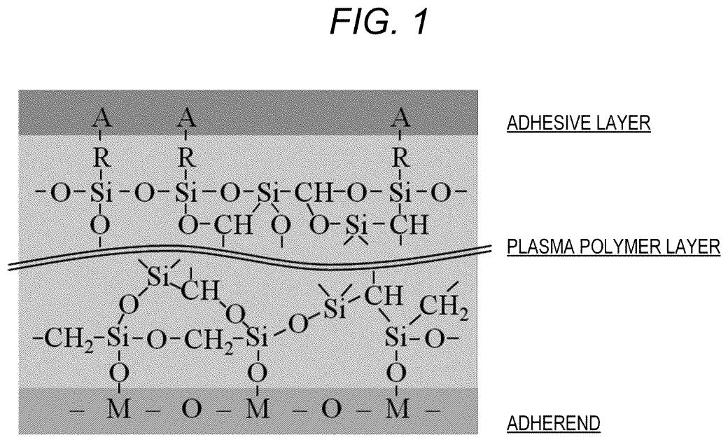

The adhesive structure of the embodiment of the disclosure is an adhesive structure including a first adherend, a first plasma polymer layer, an adhesive layer, a second plasma polymer layer, and a second adherend in this order or consisting of these layers. A relationship among the adherend, the plasma polymer layer, and the adhesive layer is illustrated in FIG. 1.

### [Adherend]

Examples of the first adherend and the second adherend include a metallic adherend (for example, a steel adherend and an aluminum adherend). Examples of the steel adherend include a non-plated steel adherend, a galvanized steel adherend, and an Al—Si plated steel adherend. Examples of the aluminum adherend include a wrought material, an extruded material, and a die cast material. The first adherend and the second adherend may be made of the same material or different materials. The thicknesses of the first adherend and the second adherend are thicknesses usually assumed in the present technical field (for example, the technical field of automobiles).

### [Plasma Polymer Layer]

Each of the first plasma polymer layer and the second plasma polymer layer contains an organopolysiloxane as a main component or consists of an organopolysiloxane. For example, each of the first plasma polymer layer and the second plasma polymer layer is a polymer coating mainly containing or consisting of an organopolysiloxane network formed by stacking a precursor put into a plasma region and fragmented on an adherend.

In some embodiments, a structural unit of the organopolysiloxane contains a structural unit derived from a precursor (preferably, mainly contains a structural unit derived from a precursor) or consists of the structural unit derived from the precursor.

As the precursor, a precursor containing a functional group reactive with a reactive group of an adhesive used for the adhesive layer is used in some embodiments. For example, the precursor contains an amino group and/or an epoxy group in some embodiments in a case of an epoxy adhesive, contains an isocyanate group and/or a hydroxy group in some embodiments in a case of a urethane adhesive, and contains an amino group and/or a thiol group in some embodiments in a case of an acrylic adhesive.

Examples of the precursor in the case of the epoxy adhesive include 3-(trimethoxysilyl) propyl glycidyl ether. In an organopolysiloxane formed in this case, a substituent (symbol R in FIG. 1) bonded to a silicon atom of a siloxane bond in the organopolysiloxane has an epoxy group.

Note that each of the first plasma polymer layer and the second plasma polymer layer may contain an organopolysiloxane as a main component or may consist of an organopolysiloxane. Alternatively, one of the first plasma polymer layer and the second plasma polymer layer may contain an organopolysiloxane as a main component, and the other may consist of an organopolysiloxane.

A lower limit value of the thickness of each of the first plasma polymer layer and the second plasma polymer layer is 10 nm or more, preferably 20 nm or more, and more preferably 30 nm or more. An upper limit value thereof is 100 nm or less, preferably 90 nm or less, and more preferably 80 nm or less. The lower limit value and the upper limit value can be combined in any manner.

When the thickness of the plasma polymer layer is less than 10 nm, sufficient corrosion resistance cannot be obtained in the adhesive layer, and an effect of suppressing aging deterioration cannot be obtained in the adhesive layer. When the thickness of the plasma polymer layer is more than 100 nm, the plasma polymer layer is brittle, and therefore destruction occurs in the plasma polymer layer when the plasma polymer layer is excessively thick, and expected adhesive performance for the structural adhesive cannot be exhibited.

The thickness of the plasma polymer layer can be measured by a known transmission electron microscope.

Each of the first plasma polymer layer and the second plasma polymer layer may be formed of a single layer or layers.

Since the plasma polymer layer is provided on a surface of the adherend, corrosion resistance can be improved, and a decrease in adhesive strength under a use environment can be suppressed. Note that when the plasma polymer layer is not provided between the adherend and the adhesive layer, by enter of water molecules and a corrosion factor (Cl or the like) into an adhesion interface between the adherend (for example, a metallic adherend) and the adhesive layer under a use environment, a surface of the adherend may change in quality (an oxide film may be grown and a corrosion product may be formed) to cause a decrease in adhesive strength (aging deterioration).

### [Adhesive Layer]

Examples of an adhesive component constituting the adhesive layer include one-liquid thermosetting, one-liquid moisture curable, and two-liquid room-temperature curable epoxy-based, urethane-based, and acrylic adhesives.

Examples of the one-liquid thermosetting epoxy-based adhesive include a mixture of bisphenol A epoxy and dicyandiamide. Examples of the two-liquid room-temperature curable epoxy-based adhesive include a mixture of a bisphenol A epoxy resin and a polyamidoamine.

Examples of the two-liquid room-temperature curable urethane-based adhesive include a mixture of a polyoxypropylene triol and diphenylmethane diisocyanate.

Examples of the one-liquid moisture curable acrylic adhesive include cyanoacrylate. Examples of the two-liquid room-temperature curable acrylic adhesive include a mixture of a mixed liquid containing a polymerization inhibitor containing methyl methacrylate as a main component and an oxidizing agent and a mixed liquid containing a reducing agent similarly containing methyl methacrylate as a main component.

The adhesive layer may be formed of a single layer or layers. The thickness of the adhesive layer is a thickness usually assumed in the present technical field (for example, the technical field of automobiles).

### [Interface Between Adherend and Plasma Polymer Layer and Interface Between Plasma Polymer Layer and Adhesive Layer]

### (Interface Between Adherend and Plasma Polymer Layer)

For example, when the adherend is a metallic adherend, as illustrated in FIG. 1, a covalent bond between a metal atom (symbol M in FIG. 1) of the metallic adherend as the adherend and an oxygen atom of a siloxane bond in an organopolysiloxane contained in the plasma polymer layer can be present at the interface between the adherend and the plasma polymer layer.

For example, at the interface between the first adherend and the first plasma polymer layer, a metal atom of the first adherend and an oxygen atom of a siloxane bond in an organopolysiloxane contained in the first plasma polymer layer can be covalently bonded to each other, and at the interface between the second plasma polymer layer and the second adherend, an oxygen atom of a siloxane bond in an organopolysiloxane contained in the second plasma polymer layer and a metal atom of the second adherend can be covalently bonded to each other.

In addition, a covalent bond between an oxygen atom (symbol O in FIG. 1) in an oxide film present on a surface of the metallic adherend and a silicon atom contained in the plasma polymer layer can also be present.

### (Interface Between Plasma Polymer Layer and Adhesive Layer)

At the interface between the plasma polymer layer and the adhesive layer, for example, as illustrated in FIG. 1, a covalent bond between a substituent (symbol R in FIG. 1) bonded to a silicon atom of a siloxane bond in an organopolysiloxane contained in the plasma polymer layer and a molecular chain (symbol A in FIG. 1) of a component constituting the adhesive layer can be present.

For example, at the interface between the first plasma polymer layer and the adhesive layer, a substituent bonded to a silicon atom of a siloxane bond in an organopolysiloxane contained in the first plasma polymer layer and a molecular chain of a component constituting the adhesive layer can be covalently bonded to each other, and at the interface between the adhesive layer and the second plasma polymer layer, a molecular chain of a component constituting the adhesive layer and a substituent bonded to a silicon atom of a siloxane bond in an organopolysiloxane contained in the second plasma polymer layer can be covalently bonded to each other.

When the adherend and the adhesive layer are bonded to each other by a hydrogen bond, water molecules may be adsorbed under a use environment, bonding force of the hydrogen bond may be reduced, and a decrease in adhesive strength (aging deterioration) may occur. On the other hand, in a case of the adhesive structure of the disclosure, since a covalent bond is present at the interface between the adherend and the plasma polymer layer and at the interface between the plasma polymer layer and the adhesive layer, unlike the hydrogen bond whose bonding force is reduced by water molecules, water molecules are not adsorbed and bonding force is not reduced, and it is possible to suppress a decrease in adhesive strength under a use environment.

### <Method for Manufacturing Adhesive Structure>

The adhesive structure of the disclosure can be obtained by a manufacturing including: forming a first plasma polymer layer on a first adherend; forming a second plasma polymer layer on a second adherend; applying an adhesive to the first plasma polymer layer and/or the second plasma polymer layer; bonding the first adherend on which the first plasma polymer layer is formed and the second adherend on which the second plasma polymer layer is formed with the adhesive interposed therebetween; and curing the adhesive to obtain an adhesive layer.

### (Step of Forming First Plasma Polymer Layer on First Adherend, and Step of Forming Second Plasma Polymer Layer on Second Adherend)

The step of forming the first plasma polymer layer on the first adherend and the step of forming the second plasma polymer layer on the second adherend in atmospheric pressure plasma can be performed, for example, using a known plasma polymer coating apparatus within the scope of common technical knowledge of those skilled in the art with reference to International Patent Application Publication WO 2018/141802 A1.

(Step of Applying Adhesive to First Plasma Polymer Layer and/or Second Plasma Polymer Layer)

The adhesive can be applied to the first plasma polymer layer and/or the second plasma polymer layer using a known adhesive coating machine.

In some embodiments, a range of the adhesive layer and/or a range of the plasma polymer layer is set such that the plasma polymer layer is covered with the adhesive layer. By covering the plasma polymer layer with the adhesive layer, it is possible to prevent the plasma polymer layer from inhibiting chemical conversion treatment and/or electrodeposition coating in coating of the adherend.

(Step of Bonding First Adherend on which First Plasma Polymer Layer is Formed and Second Adherend on which Second Plasma Polymer Layer is Formed with Adhesive Interposed Therebetween)

The first adherend on which the first plasma polymer layer is formed and the second adherend on which the second plasma polymer layer is formed can be bonded to each other with an adhesive interposed therebetween, for example, by fixing and/or assembling these by welding or mechanical fastening.

### (Step of Curing Adhesive to Obtain Adhesive Layer)

The adhesive can be cured by natural drying or heat drying. For example, when an adhesive component constituting the adhesive layer is a thermosetting adhesive, a vehicle body including the adherend, the plasma polymer layer, and the adhesive is put into a paint drying furnace, and the adhesive can be cured.

### (Other Steps)

Before the step of forming the first plasma polymer layer and the second plasma polymer layer on the adherends, a step of cleaning surfaces of the adherends by degreasing and/or plasma treatment or the like can be performed. Through this step, the effect of suppressing aging deterioration of the plasma polymer layer can be maximized.

The method for manufacturing an adhesive structure of the disclosure can be performed in a preceding step and/or a subsequent step of an adherend press working step.

The adhesive structure of the disclosure can suppress an aging deterioration phenomenon of adhesive performance, for example, in a vehicle body and a battery case.

### Embodiment

Hereinafter, the embodiment will be described. Note that the disclosure is not limited to the embodiment.

### [Preparation of Adhesive Structure]

An adhesive structure consisting of a first adherend, a first plasma polymer layer, an adhesive layer, a second plasma polymer layer, and a second adherend in this order was prepared by the following method.

First, using a plasma polymer coating apparatus (PTU1616 (trade name) manufactured by Plasmatreat GmbH), the first plasma polymer layer was formed on one surface of an automobile cold-rolled steel sheet (material: cold-rolled steel sheet SPCC; length 100 mm×width 25 mm×thickness 1.6 mm) as the first adherend by atmospheric pressure plasma treatment. For example, the first plasma polymer layer was formed by allowing a mixed gas obtained by spraying and mixing 3-(trimethoxysilyl) propyl glycidyl ether as a monomer liquid of an organopolysiloxane in a carrier gas (atmosphere) to flow into a coating gun tip, fragmenting monomers of the organopolysiloxane with plasma, and stacking the fragmented monomers on the automobile cold-rolled steel sheet.

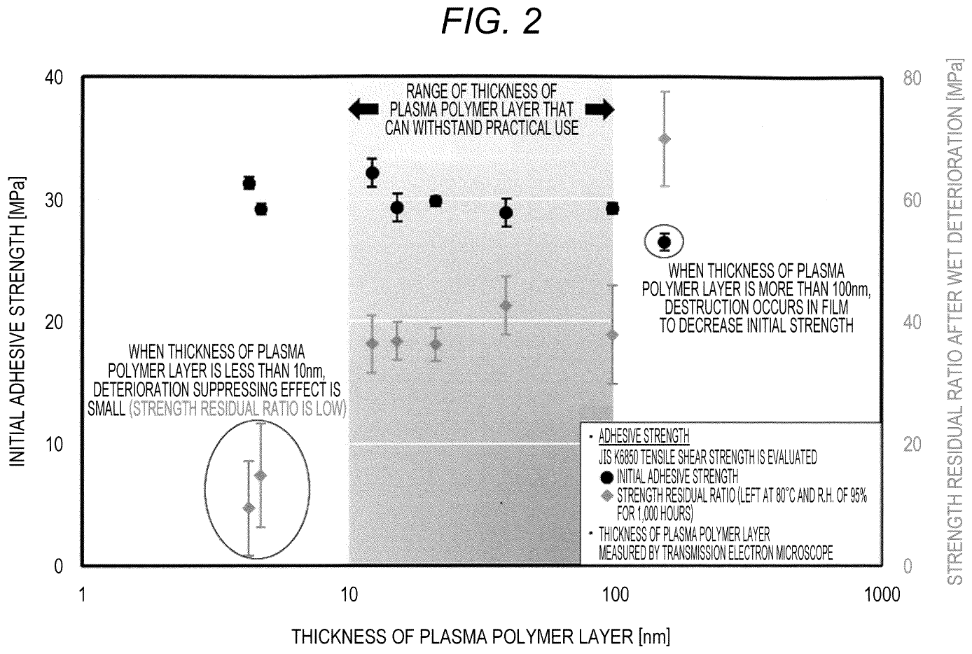

The thickness of the first plasma polymer layer was selected from a range of the thickness of the plasma polymer layer in FIG. 2 described later. The first plasma polymer layer was formed with reference to International Patent Application Publication WO 2018/141802 A1.

Next, in a similar manner to that in the formation of the first plasma polymer layer on the first adherend, the second plasma polymer layer was formed on one surface of an automobile cold-rolled steel sheet (material: cold-rolled steel sheet SPCC; length 100 mm×width 25 mm×thickness 1.6 mm) as the second adherend. Note that the thickness of the second plasma polymer layer was set to be substantially the same as the thickness of the first plasma polymer layer.

Subsequently, the adhesive layer was applied to a surface of the first plasma polymer layer on a side opposite to the first adherend. As the adhesive layer, an epoxy-based one-liquid thermosetting adhesive (for example, a mixture of bisphenol A epoxy and dicyandiamide) was used. The thickness of the adhesive layer was 0.2 mm.

Furthermore, the adhesive layer on the first adherend and the first plasma polymer layer was bonded to the second plasma polymer layer on the second adherend. Thereafter, the bonded structure was put into a paint drying furnace, and the adhesive was cured to obtain an adhesive structure.

[Influence of Thickness of Plasma Polymer Layer (Film) on Initial Adhesive Strength and Strength Residual Ratio after Wet Deterioration]

For the adhesive structure obtained in the above [Preparation of adhesive structure], tensile shear strength (adhesive strength) was measured in accordance with JISK6850. As the tensile shear strength (adhesive strength), initial adhesive strength and a strength residual ratio after wet deterioration were measured. Note that the strength residual ratio after wet deterioration is tensile shear strength (adhesive strength) of the adhesive structure after being left at 80° C. and a relative humidity of 95% for 1,000 hours.

The thickness of the plasma polymer layer (film) was measured by a transmission electron microscope (field emission transmission electron microscope Talos F200X (trade name) manufactured by FEI Company Japan Ltd.).

FIG. 2 illustrates results of an influence of the thickness of the plasma polymer layer on initial adhesive strength and a strength residual ratio after wet deterioration. In FIG. 2, the circle symbol and the error bar indicate initial adhesive strength (left vertical axis) with respect to the thickness of the plasma polymer layer (horizontal axis), and the diamond symbol and the error bar indicate a strength residual ratio after wet deterioration (right vertical axis) with respect to the predetermined thickness of the plasma polymer layer (horizontal axis). Note that the thickness of the plasma polymer layer on the horizontal axis does not mean the total thickness of the thickness of the first plasma polymer layer and the thickness of the second plasma polymer layer. For example, a case where the thickness of the plasma polymer layer on the horizontal axis is 20 nm means that the thickness of the first plasma polymer layer is 20 nm and the thickness of the second plasma polymer layer is also 20 nm.

When the thickness of the plasma polymer layer was in a range of 10 nm to 100 nm, good results were obtained for both the initial adhesive strength and the strength residual ratio after wet deterioration.

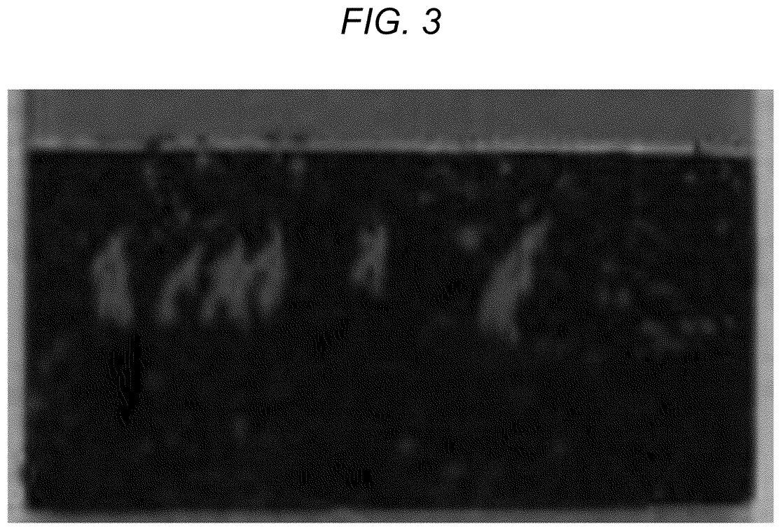

On the other hand, when the thickness of the plasma polymer layer exceeded 100 nm, destruction occurred in the formed film, and the initial strength decreased. The state of this destruction is illustrated in FIG. 3. It is considered that this destruction was caused by an excessively large thickness of the film.

When the thickness of the plasma polymer layer was less than 10 nm, the strength residual ratio after wet deterioration decreased (that is, the effect of suppressing aging deterioration was not obtained).

### [Strength Change Ratio of Adhesive Structure Under Constant Temperature and Humidity]

For the adhesive structure (embodiment) obtained in the above [Preparation of adhesive structure] and an adhesive structure (Comparative Example) not including the first plasma polymer layer and the second plasma polymer layer in the adhesive structure of the embodiment, the strength change ratios of the adhesive structures under deterioration conditions of constant temperature and constant humidity (conditions of a deterioration test simulating a use environment) were compared. Note that 80° C. and a relative humidity of 95% were used as the deterioration conditions. The experiment was performed by setting each of the thicknesses of the first plasma polymer layer and the second plasma polymer layer in each of the adhesive structures to about 20 nm.

For the adhesive structures in the embodiment and Comparative Example, tensile shear strength (adhesive strength) after a lapse of a predetermined deterioration test time was measured in accordance with JISK6850.

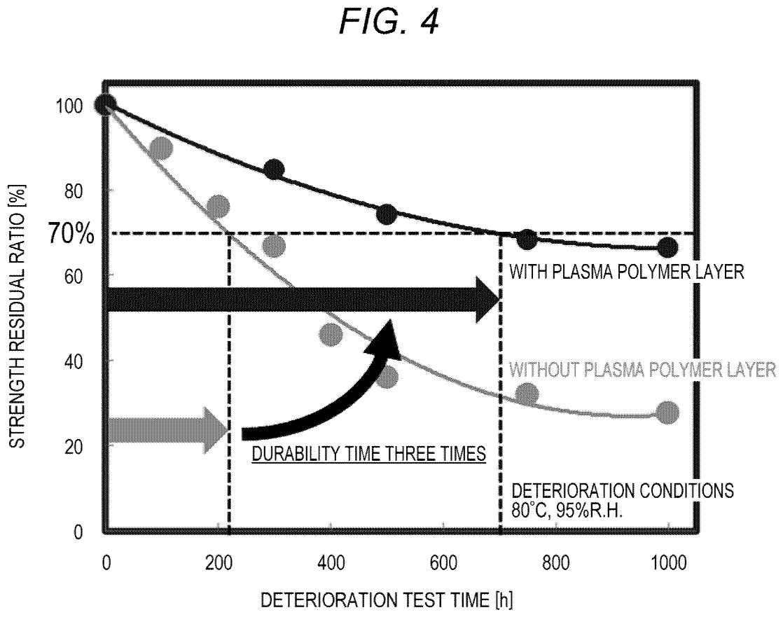

FIG. 4 illustrates results of the strength change ratios of the adhesive structures under constant temperature and constant humidity. In FIG. 4, the horizontal axis represents a deterioration test time (unit: time), and the vertical axis represents a strength residual ratio [%]. Note that the strength residual ratio [%] is calculated by adhesive strength after deterioration test [MPa]/initial adhesive strength [MPa]×100.

In the adhesive structure of the embodiment, as compared with the adhesive structure of Comparative Example, a decrease in strength residual ratio (decrease in strength) with an increase in the deterioration test time is suppressed. For example, a deterioration test time until the strength residual ratio decreased from 100% to 70% was about 200 hours in the case of the adhesive structure of Comparative Example, but was about 700 hours in the case of the adhesive structure of the embodiment. That is, in the adhesive structure of the embodiment, the deterioration test time (durability time) was about three times.

An aspect of the disclosure in order to achieve the above object provides an adhesive structure. The adhesive structure includes a first adherend, a first plasma polymer layer, an adhesive layer, a second plasma polymer layer, and a second adherend in this order.

Each of the first plasma polymer layer and the second plasma polymer layer contains an organopolysiloxane as a main component.

A thickness of each of the first plasma polymer layer and the second plasma polymer layer is in a range of 10 nm to 100 nm.

According to the disclosure, it is possible to suppress an aging deterioration phenomenon of adhesive performance (for example, a decrease in adhesive strength of a structural adhesive over time).

An aspect of the disclosure provides the adhesive structure. In the adhesive structure, a covalent bond is formed at each of an interface between the first adherend and the first plasma polymer layer, an interface between the first plasma polymer layer and the adhesive layer, an interface between the adhesive layer and the second plasma polymer layer, and an interface between the second plasma polymer layer and the second adherend.

According to the disclosure, since a covalent bond is present at the interface between the adherend and the plasma polymer layer and at the interface between the plasma polymer layer and the adhesive layer, water molecules are not adsorbed and bonding force is not reduced, and it is possible to suppress an aging deterioration phenomenon of adhesive performance (for example, a decrease in adhesive strength of a structural adhesive over time under a use environment).

An aspect of the disclosure provides the adhesive structure. In the adhesive structure, the first adherend and the second adherend are formed of metal.

At an interface between the first adherend and the first plasma polymer layer, a metal atom of the first adherend and an oxygen atom of a siloxane bond in an organopolysiloxane contained in the first plasma polymer layer are covalently bonded to each other.

At an interface between the first plasma polymer layer and the adhesive layer, a substituent bonded to a silicon atom of the siloxane bond in the organopolysiloxane contained in the first plasma polymer layer and a molecular chain of a component constituting the adhesive layer are covalently bonded to each other.

At an interface between the adhesive layer and the second plasma polymer layer, the molecular chain of the component constituting the adhesive layer and a substituent bonded to a silicon atom of a siloxane bond in an organopolysiloxane contained in the second plasma polymer layer are covalently bonded to each other.

At an interface between the second plasma polymer layer and the second adherend, an oxygen atom of the siloxane bond in the organopolysiloxane contained in the second plasma polymer layer and a metal atom of the second adherend are covalently bonded to each other.

According to the disclosure, since a covalent bond is present at the interface between the adherend and the plasma polymer layer and at the interface between the plasma polymer layer and the adhesive layer, in addition to suppressing an aging deterioration phenomenon of adhesive performance (for example, a decrease in adhesive strength of a structural adhesive over time), water molecules are not adsorbed and bonding force is not reduced, and it is possible to suppress a decrease in adhesive strength under a use environment.

An aspect of the disclosure provides the adhesive structure. In the adhesive structure, the organopolysiloxane contains a structural unit derived from a precursor.

According to the disclosure, it is possible to further suppress an aging deterioration phenomenon of adhesive performance (for example, a decrease in adhesive strength of a structural adhesive over time).

An aspect of the disclosure provides a method for manufacturing the adhesive structure. The method includes:
forming the first plasma polymer layer on the first adherend by a plasma polymer coating apparatus;
forming the second plasma polymer layer on the second adherend by the plasma polymer coating apparatus;
applying an adhesive to one or both of the first plasma polymer layer and the second plasma polymer layer;
bonding the first adherend on which the first plasma polymer layer is formed and the second adherend on which the second plasma polymer layer is formed with the adhesive interposed therebetween; and
curing the adhesive to obtain the adhesive layer.

According to the disclosure, since the adhesive structure is manufactured by the plasma polymer coating apparatus, cost is low as compared with cost of introducing a treatment bath for forming an organic film into a manufacturing process, and the adhesive structure can be manufactured without being affected by press working processing conditions (for example, processing conditions in a high temperature state).

According to the disclosure, it is possible to suppress an aging deterioration phenomenon of adhesive performance (for example, a decrease in adhesive strength of a structural adhesive over time). In addition, according to the disclosure, since the adhesive structure of the disclosure can be obtained by a plasma polymer coating apparatus, cost of introducing the plasma polymer coating apparatus into a manufacturing process is low as compared with cost of introducing a treatment bath for forming an organic film into the manufacturing process. According to the disclosure, since the adhesive structure of the disclosure can be obtained by introducing a plasma polymer coating apparatus into a subsequent step of an adherend press working step, the adhesive structure is not affected by press working processing conditions (for example, processing conditions in a high temperature state).

1. An adhesive structure comprising a first adherend, a first plasma polymer layer, an adhesive layer, a second plasma polymer layer, and a second adherend in this order, wherein
each of the first plasma polymer layer and the second plasma polymer layer contains an organopolysiloxane as a main component, and
a thickness of each of the first plasma polymer layer and the second plasma polymer layer is in a range of 10 nm to 100 nm.

2. The adhesive structure according to claim 1, wherein a covalent bond is formed at each of an interface between the first adherend and the first plasma polymer layer, an interface between the first plasma polymer layer and the adhesive layer, an interface between the adhesive layer and the second plasma polymer layer, and an interface between the second plasma polymer layer and the second adherend.

3. The adhesive structure according to claim 2, wherein
the first adherend and the second adherend are formed of metal,
at the interface between the first adherend and the first plasma polymer layer, a metal atom of the first adherend and an oxygen atom of a siloxane bond in an organopolysiloxane contained in the first plasma polymer layer are covalently bonded to each other,
at the interface between the first plasma polymer layer and the adhesive layer, a substituent bonded to a silicon atom of the siloxane bond in the organopolysiloxane contained in the first plasma polymer layer and a molecular chain of a component constituting the adhesive layer are covalently bonded to each other,
at the interface between the adhesive layer and the second plasma polymer layer, the molecular chain of the component constituting the adhesive layer and a substituent bonded to a silicon atom of a siloxane bond in an organopolysiloxane contained in the second plasma polymer layer are covalently bonded to each other, and
at the interface between the second plasma polymer layer and the second adherend, an oxygen atom of the siloxane bond in the organopolysiloxane contained in the second plasma polymer layer and a metal atom of the second adherend are covalently bonded to each other.

4. The adhesive structure according to claim 1, wherein a structural unit of the organopolysiloxane contains a structural unit derived from a precursor.

5. The adhesive structure according to claim 2, wherein a structural unit of the organopolysiloxane contains a structural unit derived from a precursor.

6. The adhesive structure according to claim 3, wherein a structural unit of the organopolysiloxane contains a structural unit derived from a precursor.

7. A method for manufacturing the adhesive structure according to claim 1, the method comprising:
forming the first plasma polymer layer on the first adherend by a plasma polymer coating apparatus;
forming the second plasma polymer layer on the second adherend by the plasma polymer coating apparatus;
applying an adhesive to one or both of the first plasma polymer layer and the second plasma polymer layer;
bonding the first adherend on which the first plasma polymer layer is formed and the second adherend on which the second plasma polymer layer is formed with the adhesive interposed therebetween; and
curing the adhesive to obtain the adhesive layer.
